(19) United States
(12) Patent Application Publication
(10) Pub. No.: US 2017/0092044 A1
(43) Pub. Date: Mar. 30, 2017

(54) GAMES AND GAMING MACHINES HAVING ACTION DYNAMIC REELS

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 15/268,594

(22) Filed: Sep. 18, 2016

Related U.S. Application Data
(60) Provisional application No. 62/233,626, filed on Sep. 28, 2015.

(51) Int. Cl. G07F 17/32; G07F 17/34

(52) U.S. Cl. CPC G07F 17/3213; G07F 17/3244; G07F 17/34

(57) ABSTRACT

A slot type game is configured to display a matrix of game symbols, such as via a plurality of reels having a number of symbol rows or positions. The reels may have a base configuration having a plurality of game symbols associated with different positions whereby combinations of different symbols may be displayed. At one or more times an action symbol is selected and associated with one or more reels, whereby each selected reel displays only the action symbol, greatly increasing the probability of a resulting game win due to the occurrence of only the action symbol with the selected reels.

### RELATED APPLICATION DATA

This application is a non-provisional of and claims priority to U.S. Provisional Application Ser. No. 62/233,626, filed Sep. 28, 2015.

### FIELD OF THE INVENTION

The present invention relates to methods of presenting and playing games and gaming machines configured to present games.

### BACKGROUND

Slot-type games are a very popular form of wagering games. In slot type games, a matrix of symbols is displayed to a player. The symbols might be associated with spinning physical reels or might be shown graphically on an electronic display. The player wins the game if one or more combinations of displayed symbols comprises a predetermined winning combination of symbols.

Various slot game features have been developed in order to make these games more exciting. For example, some symbols may act as “WILD” symbols which follow certain rules (such as comprising any other displayed symbols) which may increase the probability of obtaining a winning outcome. As another example, in nudge-type games a reel might move or “nudge” up or down one or more positions to give a player an additional opportunity to form a winning outcome.

Despite these innovations, new and exciting slot-type games are desired.

### SUMMARY

Embodiments of the invention comprise a gaming machine and methods of presenting a game on a gaming machine. The play of the game may include a slot type game where a plurality of reels having associated game symbols are used to display a matrix of game symbols.

At one or more times, one game symbol (such as from one of the positions of one of the reels) is randomly selected as a spread symbol. When a spread symbol condition is triggered, the spread symbol is duplicated to fill all positions of at least one of the reels (by changing the symbols associated with positions of that reel or by substituting a new reel strip having only the spread symbol). Thus, when the spread symbol condition is triggered, the outcome of the game is that one or more of the reel display only the spread symbol, greatly increasing the probability of a game winning outcome to the player.

Further objects, features, and advantages of the present invention over the prior art will become apparent from the detailed description of the drawings which follows, when considered with the attached figures.

### BRIEF DESCRIPTION OF THE DRAWINGS

FIG. 1 illustrates a casino gaming machine, according to one exemplary embodiment;

FIG. 2 is a flow chart which illustrates a spread symbol action game, according to one exemplary embodiment;

FIGS. 3A, 3B, 3C, and 3D illustrate examples of a spread symbol action game, according to one exemplary embodiment; and

FIG. 4 illustrates an alternate example of a spread symbol action game, according to one exemplary embodiment.

### DETAILED DESCRIPTION OF THE EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games. In a preferred embodiment, the methods of game play and presentation are implemented via a gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

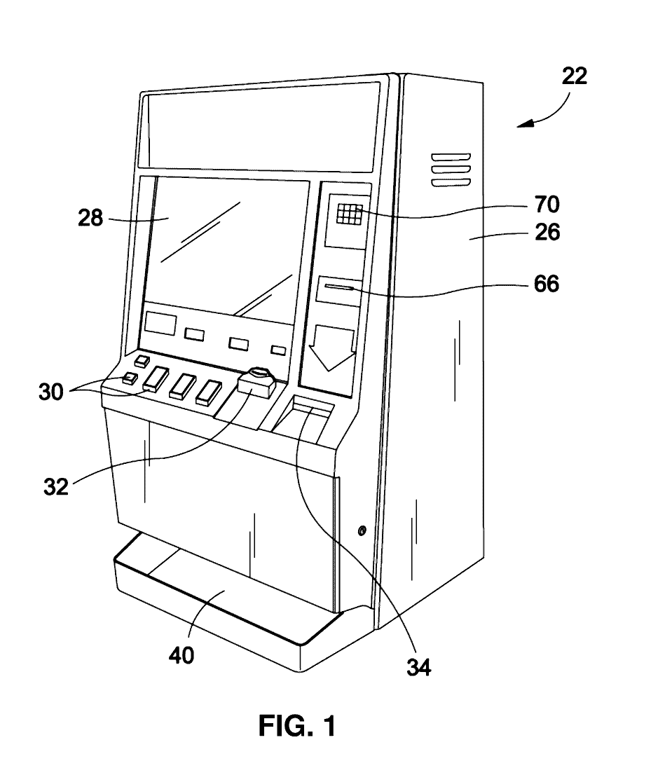

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes a mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 22 preferably includes a mechanism or means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate a reel spin, to “cash out” of the gaming machine, or to provide various other inputs.

In one preferred embodiment, the gaming machine 22 includes at least one microprocessor or controller for controlling the gaming machine, including receiving player input and sending output signals for controlling the various components or peripheral devices of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information comprising slot reel symbols, as detailed below), for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to look-up tables, pay tables and other information, including tracked game play information). The gaming machine 22 may also include one or more random number generators for generating random numbers (such as implemented by a random number generator software module stored in the memory and executable by the processor or controller), such as for use in selecting slot or game symbols and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions (e.g. software) which are configured to implement the game. In this regard, the gaming machine is specially configured to present the game of the invention via specific software and/or hardware which causes the gaming machine to operate uniquely. For example, the controller of the gaming machine 22 may be configured to detect a wager, such as a signal from a player's depressing of the “bet one” button. Upon such an event and/or the player otherwise signaling the gaming machine to present the game, the controller may be configured to cause the at least one display 28 to display unique information, such as a unique graphical interface or unique game display, including game symbols or other game information. The controller may accept input from a player of game inputs, such as a request to spin reels or the like, via the one or more player input devices of the gaming machine 22. As indicated above, the machine readable code may be configured in various manners, such as by having various “modules” of software which are designed to implement specific features of the game play or game presentation.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. The gaming machines 22 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communication links, such as to enable the transfer of funds from the player to the gaming machine or system).

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming machine 22 dispensing coins to a coin tray. In another embodiment, funds may be issued by dispensing paper currency or other media. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, instead of comprising a “casino”-style gaming machine, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

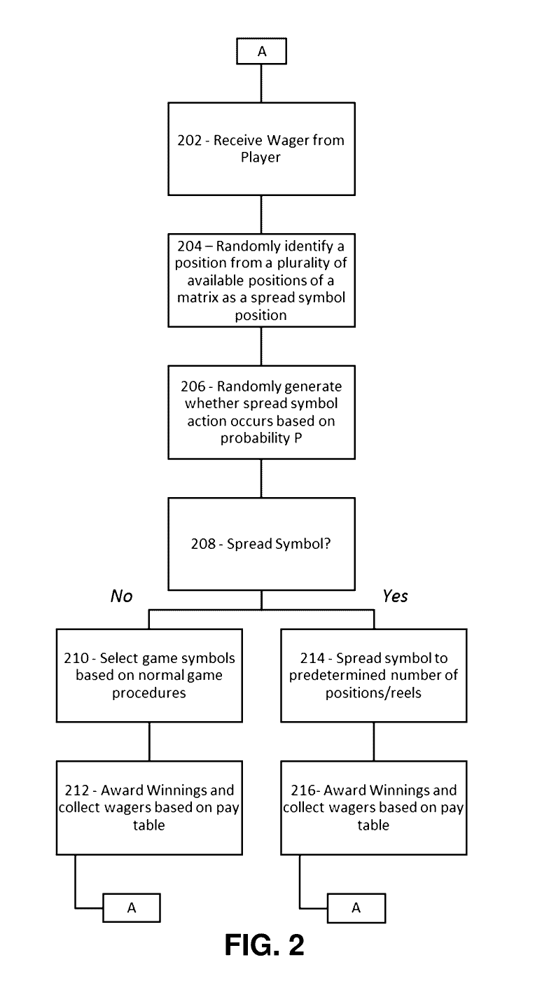

One embodiment of a method of playing and presenting a game in accordance with an embodiment of the invention will be described with reference to FIGS. 2-4. In general, in accordance with one embodiment of the invention, the symbols associated with one or more columns or reels of a slot game are modified to be identical, thus increasing the odds of receiving a winning combination of symbols.

An example of the play of such as a game is shown in FIG. 2. Here in step 202, a wager may be received from the player at a gaming machine. The gaming machine may receive the wager from the player in any suitable manner as discussed above.

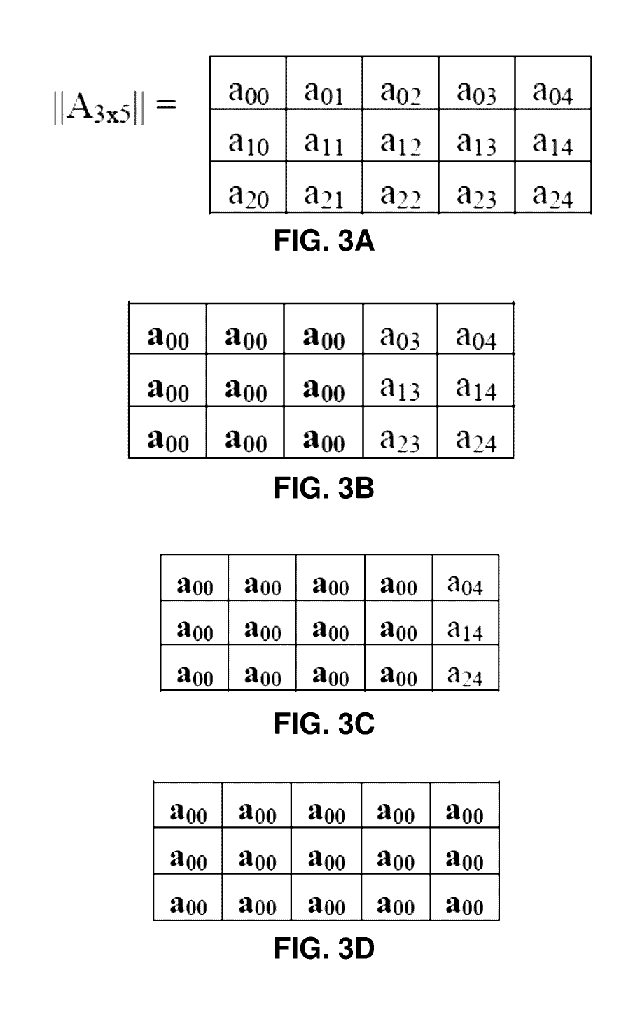

The controller of the gaming machine via a random number generator preferably randomly identifies a position from a plurality of available position of a matrix as a spread symbol position p in step 204. For example in FIG. 3A, there is a matrix A with five columns and three rows. The columns represent reels of a slot type game. Thus, in the example, matrix A_{3×5} has five reels with three positions on each reel. However, this is only exemplary and each reel may include a number of positions greater than three. For example, in one embodiment, each reel may be configured to display three symbol positions to the player but may have a greater number of real or virtual symbol positions. For example, each reel might be a virtual reel strip having 30 symbol positions each having an associated game symbol. A “stop” position (e.g. reel strip position) might be randomly selected for each reel and the corresponding three symbols associated with the stop position might then be displayed to the player.

The positions are identified in FIG. 3A corresponding to the row and column. For example, a₀₀ is the position in an initial row and an initial column, a₀₁ is in the position of the initial row and a second column, and so forth. Each of the positions may be randomly assigned a game indicia, as is known in the art. One of the positions is selected as the random position p to be the spread symbol. In this embodiment, position a₀₀ is selected as the spread symbol. In other embodiments, the action or spread symbol could simply be selected from a set of game symbols which are used in the game.

Returning to FIG. 2, the gaming machine randomly generates whether the spread symbol action is to occur based on a probability P in step 206. Based on an outcome of a random number generator there is a probability P that the spread symbol action will or will not occur. In step 208, it is determined whether the outcome of step 206 triggered a spread symbol action.

In step 210, when no spread symbol action is triggered, the game continues according to normal game procedures. That is, the reals shown in the exemplary matrix A_{3×5} are spun, or positions of the real are randomly selected to be displayed. Preferably, the base configuration of each reel is such that each reel has a plurality of different game symbols associated therewith. The plurality of game symbols may be spread amongst the reels in various manners, wherein the game symbols may occur with the same or differing frequency on each reel or between different reels. In general, in this manner there may be various probabilities for receiving game outcomes, including winning and losing outcomes. For example, some game symbols might have a low frequency of appearance on one or more of the reels, making the probability of receiving certain winning outcomes very low.

In step 212, winnings are awarded or wagers are collected based on the outcome of the game according to a predetermined pay table wherein certain outcomes are generally designated as losing and certain outcomes are designated as winning (and preferably have an associated award). Generally, certain combinations of symbols, such as the occurrence of a plurality of the same game symbol on the plurality of reels, is designated as winning. For example, if a predetermined pattern a symbols are displayed along a pay line of the gaming machine or in a scatter configuration as a result of the normal game play, then a payout may be awarded to the player.

On the other hand, when it is determined that the spread symbol is triggered in step 208, then the game play proceeds to step 214. In step 214, the spread symbol is duplicated onto a predetermined number of reels (e.g. entire columns of the slot symbol matrix). For example as shown in FIG. 3B, the symbol disposed on position a₀₀ is duplicated so that each position in the first three columns, or on the first three reels, is set to show the symbol on position a₀₀. Therefore, when the reels are spun, or the positions to display to the player are generated, it is guaranteed that the symbol on position a₀₀ will be displayed in all displayed positions of the first three reels. The effect is that when the spread symbol action occurs based on the probability P, the player has the opportunity to easily obtain attractive wins because of the frequency of the occurrence of the symbol.

The “action symbol” may be spread to one or more reels in various manners. In one embodiment, as described above, reach reel may comprise a virtual reel strip having game symbols associated with positions. In one configuration, the game symbol associated with each reel position of a designated reel may be changed to the action symbol. In another embodiment, an entire new reel strip is utilized. For example, a first reel might have a base configuration of 30 symbol positions having a plurality of game symbols assigned to those positions. In one embodiment, the first reel might be replaced with an action reel having all positions filled with the action symbol. In either manner, no matter which reel position or stop is randomly selected, the modified or “action” first reel will display only the action symbol to the player as the outcome of the reel spin.

In other examples, the action or spread symbol may be configured to be duplicated onto four of the columns or reels, as shown in FIG. 3C (in this example, the action symbol was selected to be symbol a₀₀ but it could be another symbol). In another example, the action or spread symbol is duplicated onto all columns or reels as shown in FIG. 3D (again, in this example, the action symbol was selected to be symbol a₀₀ but it could be another symbol). This further enhances the player's ability to obtain attractive wins because of the further increased number of displayed action symbols. Again, the spreading of the action symbol to these other reels or columns can be performed in various manners as described above.

In accordance with this game feature the game is played using reels having the action symbol. This results in one or more of the reels displaying only the action symbol. In step 216, it is determined if the player received a winning outcome and winnings are awarded or wagers are collected based on the resulting outcome according to a pay table.

In one embodiment, the action or spread symbol which is selected may be a symbol that is designated to be a winning symbol in accordance with the pay table. In other embodiments, the action or spread symbol could be any symbol, even one which in one or more combinations will not result in a game win.

In some embodiments, there may be different probabilities assigned to the different duplication actions. For example, there may be a probability P1 that the spread symbol is duplicated across three reels. There may be a probability P2 that the spread symbol is duplicated across four reels. Similarly, there may be a probability P3 that the spread symbol is duplicated across all reels. The sum of probabilities P1, P2, and P3 may be equal to the total probability of the spread symbol being triggered P. That is, P1+P2+P3. It will be appreciated that different probabilities may be assigned. For example, in one embodiment, the probability that the action reel feature is implemented may be relatively low (e.g. the game will be then be presented in its base configuration most of the time). Further, the probability that the action symbol is spread to a first number of reels (such as 3 reels or columns) may be a probability P1 which is higher than a probability P2 that the action symbol is spread to a higher second number of reels (such as four reels or columns), which may be higher than a probability P3 that the action symbol is spread to an even higher third number of reels (such as all five reels or columns). Of course, these probability may vary.

Further, the action or spread symbol might be associated with differing numbers of reels. For example, the action or spread symbol might be associated with as few as 1 or 2 reels (instead of starting with 3 reels), or might be associated with fewer than all reels. For example, in one embodiment there might be a first probability that the action or spread symbol would be spread to 2 reels and another probability that the action or spread symbol would be spread to 4 reels.

As described herein, in one embodiment the action or spread symbol may be assigned or associated with the reels or columns from left to right, such as corresponding to a stopping order of the reels. Of course, the action or spread symbol might be associated with just the right-most reel, starting with the center reel, etc.

It will be appreciated that the order of the steps illustrated in FIG. 2 and described above may vary. For example, in one embodiment it may be first determined whether the game is to be played in its base configuration or if the action reel feature has been triggered. If the action reel feature has been triggered, then an action or spread symbol might be selected.

In one embodiment, the probability of the action reel feature being triggered (and/or the probability of it applying to particular numbers of reels or columns) might vary depending upon certain criteria, such as the size of a player's wager. For example, the probability of the action reels applying to all of the reels may be 0 if the player does not place a maximum wager and might be 5% if the player places a maximum wager.

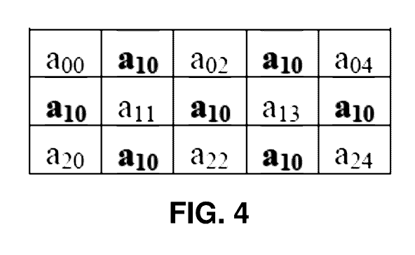

While the above examples show that the spread symbol is duplicated onto one or more entire reels, the invention is not limited to this. For example, the spread symbol may be duplicated onto a number of predetermined positions without filling the positions of an entire reel. For example as shown in FIG. 4, the randomly selected spread symbol is a₁₀ (the position in the second row, first column). When the spread symbol is triggered, the symbol duplicates into a pattern of positions where every other position includes the duplicated symbol a₁₀. Other patterns for duplicating the spread symbol may also be incorporated.

The above game and gaming machine provides a number of advantages to the player. The player may have the opportunity to win significant awards in a reel specific way based on the duplication of the action or spread symbol. The result may be that static or base reels may be combined with reels having the duplicated spread symbol to create the opportunity for enhanced wins. Further, because the action symbol is associated with each position of an entire reel (or at least all displayed positions thereof), the benefit of the action symbol is not dependent upon a pay line that may be selected by the player.

The player also has an enhanced experience. For example, after the player makes a wager on a selected number of pay lines, the reels spin to show the player whether or not he or she has won an award. When the probability P occurs that the spread symbol is triggered, the spinning reels show that all positions have the matching action symbol, creating the anticipation in the player that a substantial win is highly likely. In one embodiment, the reels may be spun and/or stopped in a sequence, such as from left to right. In this configuration, when the action symbol may be spread to at least the first or left-most reel (or a greater number of reels from left to right), then when the first or left-most reel stops it will show all action symbols. The player then has a sense of high anticipation for a win based upon the stopping of the remaining reels.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a controller;
at least one electronic display;
at least one player input device;
machine-readable code executable by said controller to cause said gaming machine to:
identify a spread symbol out of a matrix of symbols on a plurality of reels, said matrix having at least two columns and at least one row;
establish a probability of a spread symbol trigger; and
when said spread symbol trigger is activated by a random number generator of the gaming machine based on the probability, duplicate the spread symbol to all positions of at least one column in the matrix of symbols.
